(19) United States
(12) Patent Application Publication
(10) Pub. No.: US 2019/0057479 A1
(43) Pub. Date: Feb. 21, 2019

(54) SYSTEMS AND METHODS FOR DISPATCHING VEHICLES

(71) Applicant: BEIJING DIDI INFINITY TECHNOLOGY AND DEVELOPMENT CO., LTD., Beijing (CN)

(72) Inventors: Lu LI, Beijing (CN); Niping ZHANG, Beijing (CN); Chenyi SHI, Beijing (CN)

(73) Assignee: BEIJING DIDI INFINITY TECHNOLOGY AND DEVELOPMENT C O., LTD., Beijing (CN)

(21) Appl. No.: 15/857,825

(22) Filed: Dec. 29, 2017

(30) Foreign Application Priority Data
Aug. 16, 2017 (CN) 201710703123.5

(51) Int. Cl. G06Q 50/30; G06Q 10/06

(52) U.S. Cl. CPC G06Q 50/30; G06Q 10/06315

(57) ABSTRACT

Embodiments of the disclosure provide methods and systems for dispatching vehicles. The method may include determining, for a geographic region, supply and demand information for a transportation service during a predetermined time interval. The method may also include determining at least one over-supplied zone and at least one under-supplied zone within the geographic region, based on the supply and demand information. The method may further include notifying a vehicle in the at least one over-supplied zone information of the at least one under-supplied zone, the vehicle being available for providing the transportation service.

### CROSS REFERENCE TO RELATED APPLICATION

The present application is based on and claims the benefits of priority to Chinese Application No. 201710703123.5, filed Aug. 16, 2017, the entire contents of which are incorporated herein by reference.

### TECHNICAL FIELD

The present disclosure relates to systems and methods for dispatching vehicles, and more particularly to, systems and methods for coordinating supply and demand of a transportation service in a given geographic region.

### BACKGROUND

Drivers and passengers of an on-demand transportation service (e.g., taxi, limousine, etc.) often encounter problems caused by imbalance between the demand for the transportation service and the supply of the transportation service. For example, in situations including morning and evening rush hours, extreme weather, arrival of a train or flight, the demand may exceed the supply in certain parts of a geographic region (e.g., industrial parks, shopping malls, central business districts, train stations, and/or airports of a metropolitan area), while simultaneously the supply may exceed the demand in other parts of the geographic area (e.g., residential areas, suburbs, and/or tourist areas of the same metropolitan area).

Due to this mismatch between the geographic distribution of the demand and the geographic distribution of the transportation capacity, many passengers may have difficulties in booking a vehicle or experience long wait times in the under-supplied zones, but meanwhile many empty service vehicles have to idle in the over-supplied zones. Thus, this mismatch not only lowers the user experience of the passengers, but also prevents the drivers from maximizing their earnings. Accordingly, it is desirable to coordinate the supply and demand of the transportation service across the entire geographic region, so as to improve the operation efficiency of the transportation service.

However, conventional technology lacks the means to closely track the change of supply and demand of the transportation service in real time or over a large geographic region (e.g., the entire metropolitan area). As such, current vehicle-dispatching systems often take a long time to respond to a demand surge, and can only solve mismatch of demand and supply within a small area. Moreover, because the current systems cannot coordinate the supply and demand in a given geographic region as a whole, dispatching service vehicles to an under-supplied zone may cause new vehicle shortages in other surrounding zones. For example, a dispatcher may broadcast a message indicating there is a demand surge at the train station. However, due to the lack of overall consideration over the entire metropolitan region, the dispatching of service vehicles to the train station may cause new shortages in other places, such as central business districts.

The disclosed systems and methods for dispatching vehicles are directed to mitigating or overcoming one or more of the problems set forth above and/or other problems in the prior art.

### SUMMARY

Embodiments of the disclosure provide a computer-implemented method for dispatching vehicles. The method may include determining, for a geographic region, supply and demand information for a transportation service during a predetermined time interval. The method may also include determining at least one over-supplied zone and at least one under-supplied zone within the geographic region, based on the supply and demand information. The method may further include notifying a vehicle in the at least one over-supplied zone information of the at least one under-supplied zone, the vehicle being available for providing the transportation service.

Embodiments of the disclosure further disclose a device for dispatching vehicles. The device may include a memory storing instructions. The device may further include at least one processor configured to execute the instructions to: determine, for a geographic region, supply and demand information for a transportation service during a predetermined time interval; determine at least one over-supplied zone and at least one under-supplied zone within the geographic region, based on the supply and demand information; and notify a vehicle in the at least one over-supplied zone information of the at least one under-supplied zone, the vehicle being available for providing the transportation service.

Embodiments of the disclosure further disclose a non-transitory computer-readable medium that stores a set of instructions, when executed by at least one processor of an electronic device, cause the electronic device to perform a method for dispatching vehicles. The method may include determining, for a geographic region, supply and demand information for a transportation service during a predetermined time interval. The method may also include determining at least one over-supplied zone and at least one under-supplied zone within the geographic region, based on the supply and demand information. The method may further include notifying a vehicle in the at least one over-supplied zone information of the at least one under-supplied zone, the vehicle being available for providing the transportation service.

It is to be understood that both the foregoing general description and the following detailed description are exemplary and explanatory only and are not restrictive of the invention, as claimed.

### BRIEF DESCRIPTION OF THE DRAWINGS

FIG. 1 is a schematic diagram illustrating an exemplary vehicle-dispatching system, according to an exemplary embodiment.

FIG. 2 is a schematic diagram illustrating an exemplary communication device used in the system of FIG. 1, according to an exemplary embodiment.

FIG. 3 is a flowchart of a method for dispatching vehicles, according to an exemplary embodiment.

FIG. 4 is a schematic diagram illustrating a geographic region, according to an exemplary embodiment.

FIG. 5 is a flowchart of a method for dispatching vehicles, according to an exemplary embodiment.

FIG. 6 is a flowchart of a method for dispatching vehicles, according to an exemplary embodiment.

### DETAILED DESCRIPTION

Reference will now be made in detail to exemplary embodiments, examples of which are illustrated in the accompanying drawings and disclosed herein. Wherever convenient, the same reference numbers will be used throughout the drawings to refer to the same or like parts.

The disclosed embodiments are directed to computer systems and methods for dispatching vehicles. In particular, the disclosed system studies the supply and demand information, such as the amounts of supply and demand for a transportation service in a given geographic region and identifies “hot zones” and “cold zones” in the geographic region. As described herein, a “hot zone” is a sub-region under-supplied with the transportation service, and a “cold zone” is a sub-region over-supplied with the transportation service. Moreover, an “available vehicle” is a vehicle currently available for providing the transportation service. The disclosed system may determine the distances between the cold zones (or available vehicles in the cold zones) and the hot zones, and notify one or more available vehicles information of the hot zone(s) by, for example, providing each available vehicle with dispatch information indicating a list of hot zone(s) that are close to the available vehicle.

The disclosed systems and methods may be used in an online hailing platform (e.g., DiDi™ online) that can receive a transportation service request from a passenger and then route the service request to at least one transportation service provider (e.g., a taxi driver, a private car owner, or the like). The service request can be picked up by a service provider, or assigned to a service provider if no one picks up the service request within a predetermined period.

The transportation service is not limited to transporting passengers. For example, the transportation service may also include delivering goods or food by a vehicle. Moreover, although the following description assumes the disclosed systems and methods are used to dispatch vehicles, it is contemplated that they can be applied in any technology areas that require coordinating supply and demand of certain resources. For example, the disclosed systems and methods may be used to in organizing workers in a factory or deploying sales clerks in a busy shopping center.

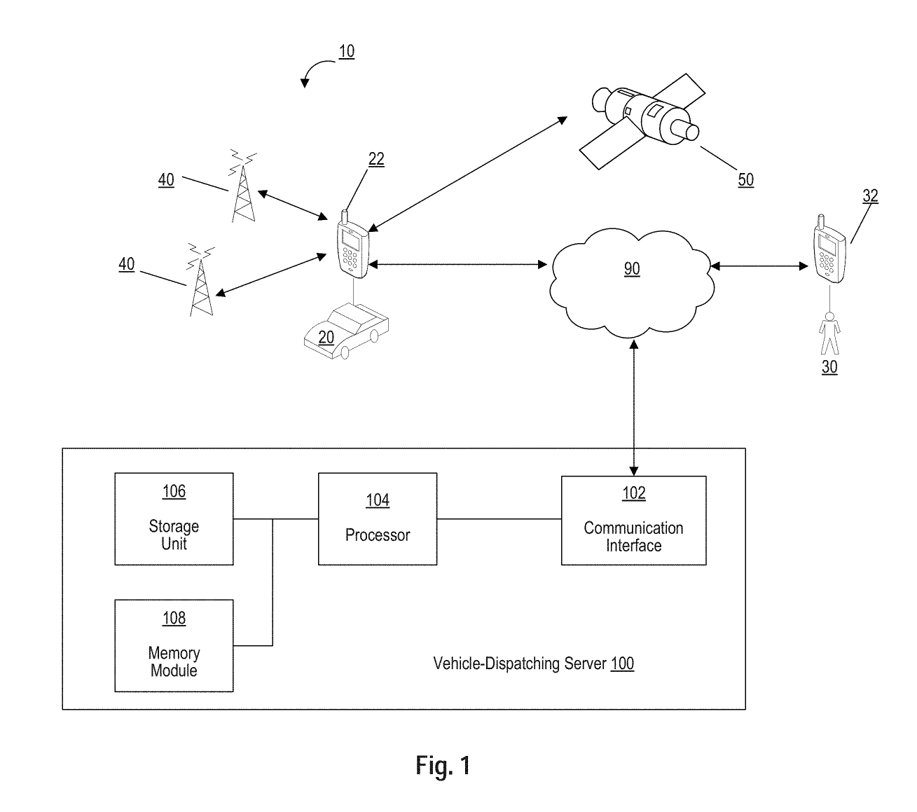

FIG. 1 is a schematic diagram illustrating an exemplary vehicle-dispatching system 10, according to an exemplary embodiment. In particular, as described below, system 10 may be configured to dispatch vehicles available for providing a transportation service (“available vehicles”) from cold zones to hot zones.

Referring to FIG. 1, system 10 may include a vehicle-dispatching server 100. Server 100 may be a general-purpose server or a proprietary device specially designed for dispatching vehicles. It is contemplated that, server 100 can be a separate system or an integrated component of a larger computing system. In some embodiments, server 100 may include sub-systems, some of which may be remote.

Consistent with the disclosed embodiments, server 100 may include, among other things, a communication interface 102, a processor 104, a storage unit 106, and a memory module 108. At least some of these components of server 100 may be configured to transfer data and send or receive instructions between or among each other.

Communication interface 102 may be configured to communicate with one or more service vehicles 20 and passengers 30. Specifically, each service vehicle 20 may have an associated communication device 22 used for communicating with server 100. Consistent with the disclosed embodiments, communicating device 22 may be integrated in vehicle 20, or may be a mobile terminal, e.g., a smart phone, a tablet computer, a wearable device, etc., carried by the driver of vehicle 20. Communication interface 102 may receive vehicle information of service vehicle 20 from communication device 22. Service vehicle 20 may be a taxi car or a private car. It is contemplated that service vehicle 20 can also be an autonomous vehicle. The vehicle information may include at least one of location, capacity, current driving direction, vehicle model, or other features of service vehicle 20.

Similarly, each passenger 30 may have an associated passenger terminal 32 used for communicating with server 100. For example, passenger terminal 32 may be a smart phone, a tablet, a wearable device, a computer, or the like. Passenger 30 may use passenger terminal 32 to send a transportation service request to server 100. The transportation service request may include a current location of passenger 30, an origin and a destination of the requested transportation service, a request time, or the like. Generally, the origin of the requested transportation service can overlap with a location of passenger 30 and/or passenger terminal 32. However, it is contemplated that the origin of the requested transportation can also differ from the location of passenger terminal 32, even if the transportation service request is sent from passenger terminal 32. For example, a user can request a transportation service from a computer for her friend, who is distant from this user.

In various disclosed embodiments, communication interface 102 may be an integrated services digital network (ISDN) card, cable modem, satellite modem, or a modem to provide a data communication connection between server 100 and other devices, such as communication device 22 and passenger terminal 32. As another example, communication interface 102 may be a local area network (LAN) card to provide a data communication connection to a compatible LAN. Wireless links can also be implemented by communication interface 102. In such an implementation, communication interface 102 can send and receive electrical, electromagnetic or optical signals that carry digital data streams representing various types of information via a network 90. Network 90 may typically include a cellular communication network, a Wireless Local Area Network (WLAN), a Wide Area Network (WAN), or the like.

Processor 104 may be one or more known processing devices, such as a microprocessor from the Pentium™ family manufactured by Intel™ or the Turion™ family manufactured by AMD™. Processor 104 may constitute a single core or multiple core processors that executes parallel processes simultaneously. For example, processor 104 may be a single core processor configured with virtual processing technologies. In certain embodiments, processor 104 may use logical processors to simultaneously execute and control multiple processes. Processor 104 may implement virtual machine technologies, or other known technologies to provide the ability to execute, control, run, manipulate, store, etc. multiple software processes, applications, programs, etc. In another embodiment, processor 104 may include a multiple-core processor arrangement (e.g., dual, quad core, etc.) configured to provide parallel processing functionalities to allow server 100 to execute multiple processes simultaneously. One of ordinary skill in the art would understand that other types of processor arrangements could be implemented that provide for the capabilities disclosed herein.

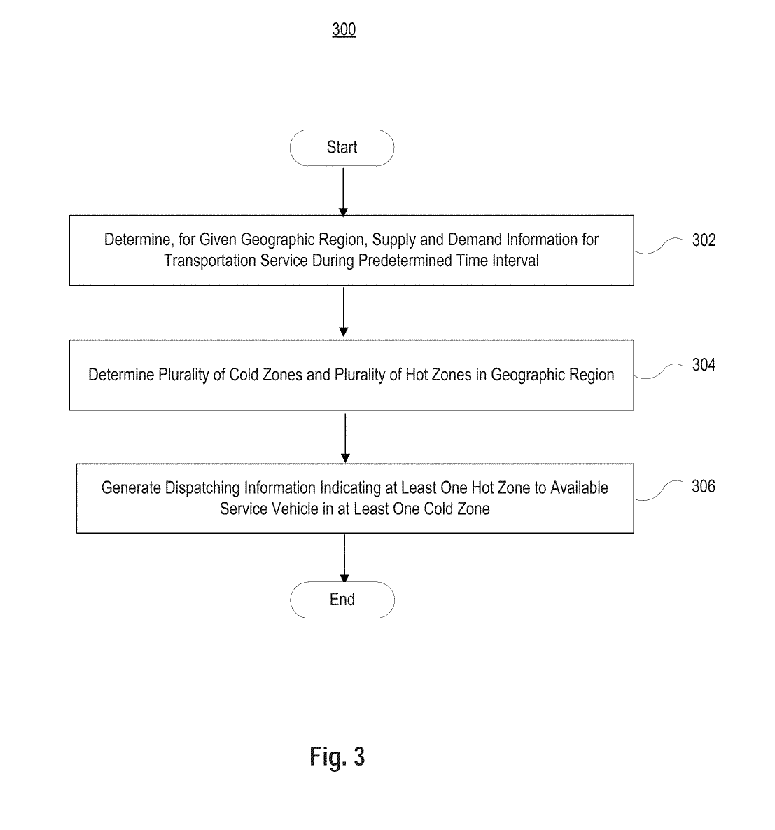

Processor 104 may execute computer instructions (program codes) stored in storage unit 106 and memory module 108, and may perform functions in accordance with exemplary techniques described in this disclosure. More exemplary functions of processor 104 will be described later in relation to FIGS. 3-6.

Storage unit 106 and memory module 108 may include any appropriate type of mass storage provided to store any type of information that processor 104 may need to operate. Storage unit 106 and memory module 108 may be a volatile or non-volatile, magnetic, semiconductor, tape, optical, removable, non-removable, or other type of storage device or tangible (i.e., non-transitory) computer-readable medium including, but not limited to, a ROM, a flash memory, a dynamic RAM, and a static RAM. Storage unit 106 and/or memory module 108 may be configured to store one or more computer programs that may be executed by processor 104 to perform exemplary functions for dispatching vehicles, as disclosed in this application. For example, storage unit 106 and/or memory module 108 may be configured to store program(s) that may be executed by processor 104 to determine the amounts of demand and supply of the transportation service for a given geographic region, and determine a plurality of cold zones and a plurality of hot zones in the geographic region based on the amounts of demand and supply. Moreover, the program(s) may be executed by processor 104 to determine distances between the cold zones (or available service vehicles in the cold zones) and the hot zones, and generate vehicle-dispatching information based on the distances.

Storage unit 106 and/or memory module 108 may be further configured to store information and data used by processor 104. For instance, storage unit 106 and/or memory module 108 may be configured to store map data of the geographic region. As another example, storage unit 106 and/or memory module 108 may be configured to store criteria used by processor 104 to determine whether a sub-region of the geographic region is a hot zone or a cold zone.

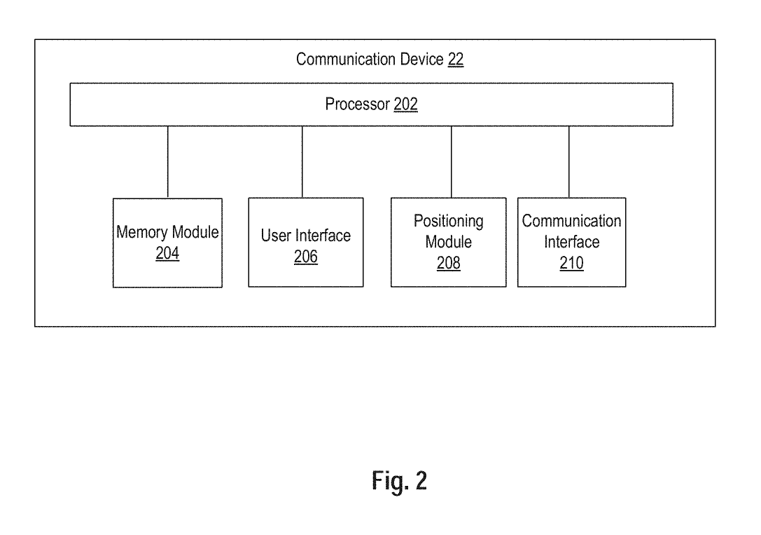

FIG. 2 is a schematic diagram illustrating an exemplary communication device 22 associated with service vehicle 20, according to an exemplary embodiment. As shown in FIG. 2, communication device 22 may include a processor 202, a memory module 204, a user interface 206, a positioning module 208, and a communication interface 210.

In exemplary embodiments, processor 202 may include any appropriate type of general purpose or special-purpose microprocessor, digital signal processor, or microprocessor. Processor 202 may be configured as a separate processor module dedicated to performing the disclosed methods for dispatching vehicles. Alternatively, processor 202 may be configured as a shared processor module for performing other functions of communication device 22 unrelated to the disclosed methods for dispatching vehicles. In the exemplary embodiments, processor 202 may execute computer instructions (program codes) stored in memory module 204, and may perform functions in accordance with exemplary techniques described in this disclosure.

Memory module 204 may include any appropriate type of mass storage provided to store any type of information that processor 202 may need to operate. Memory module 204 may be a volatile or non-volatile, magnetic, semiconductor, tape, optical, removable, non-removable, or other type of storage device or tangible (i.e., non-transitory) computer-readable medium including, but not limited to, a ROM, a flash memory, a dynamic RAM, and a static RAM. Memory module 204 may be configured to store one or more computer programs that may be executed by processor 202 to perform the disclosed methods for dispatching vehicles.

User interface 206 may be configured to receive user input from the driver of service vehicle 20 and send the user input to processor 202 for further processing. For example, user interface 206 may be implemented as a touch screen to receive input signals from the driver. The touch screen includes one or more touch sensors to sense touches, swipes, and other gestures on the touch screen. The touch sensors may not only sense a boundary of a touch or swipe action, but also sense a period of time and a pressure associated with the touch or swipe action. Alternatively or in addition, user interface 206 may include other input devices such as keyboards, buttons, joysticks, and/or tracker balls.

User interface 206 may allow the driver of service vehicle 20 to input the vehicle information of service vehicle 20. For example, the vehicle information may include the current position of service vehicle 20. As another example, the vehicle information may indicate whether service vehicle 20 is currently serving a passenger or available for picking up a new passenger.

Besides allowing the driver to manually input the position information of service vehicle 20, communication device 10 may also use positioning module 208 to automatically determine position information of service vehicle 20. Positioning module 208 may be configured as hardware, software, or a combination thereof. For example, positioning module 208 may be a Global Positioning System (GPS) receiver configured to receive GPS signals from a satellite system 50 (FIG. 1) and determines the position of service vehicle 20 based on the GPS signals. As another example, positioning module 208 may be a General Packer Radio Service (GPRS) module configured to communicate with cellular base stations 40 (FIG. 1) near service vehicle 20. The GPRS module may scan the surrounding cellular base stations 40 and determine the position of service vehicle 20 based on the positions of the detected cellular base stations 40.

Communication interface 210 can access a wireless network, e.g., network 90, based on one or more communication standards, such as WiFi, LTE, 2G, 3G, 4G, 5G, etc. Communication interface 210 may have a configuration similar to communication interface 102. As described in more detail below, communication interface 210 may be configured to send vehicle information to server 100 and receive vehicle-dispatching information from server 100.

The structures of passenger terminal 32 are similar to those of communication device 22, which will not be repeated herein. It is to be understood that the configuration and boundaries of the functional building blocks of system 10 (FIG. 1) have been defined herein for the convenience of the description. Alternative boundaries may be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

FIG. 3 is a flowchart of an exemplary method 300 for dispatching vehicles, according to an exemplary embodiment. For example, method 300 may be implemented by vehicle-dispatching server 100. Referring to FIG. 3, method 300 may include steps 302-306 as described below.

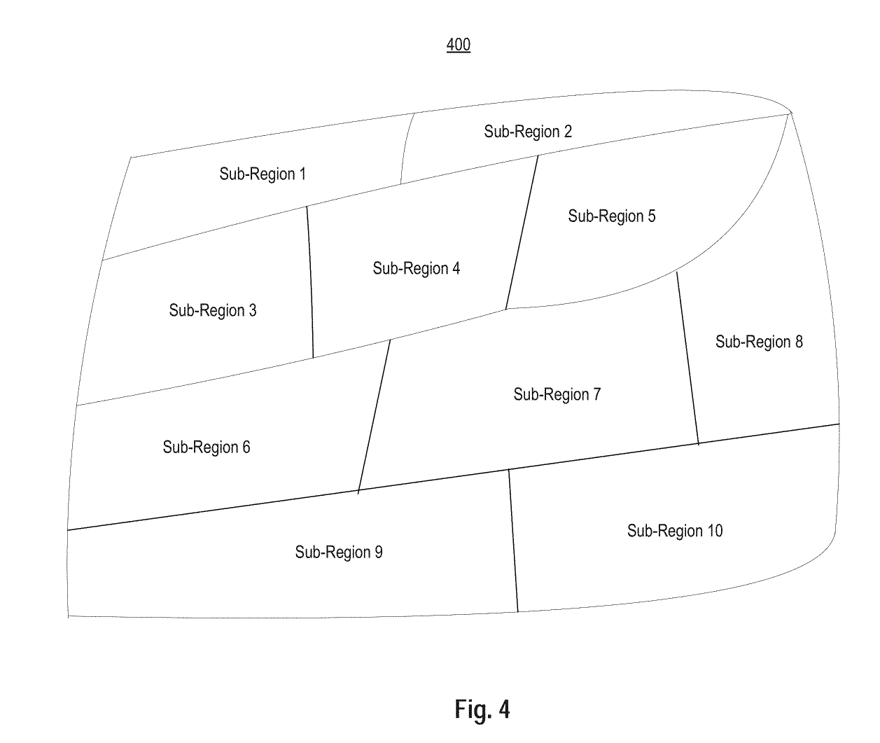

In step 302, server 100 may determine, for a given geographic region, supply and demand information for a transportation service during a predetermined time interval. FIG. 4 is a schematic diagram illustrating a geographic region 400, according to an exemplary embodiment. Referring to FIG. 4, geographic region 400 may correspond to any particular designated region, e.g., a region covering a certain radius of a landmark, a city, a metropolitan area, a county, etc. Server 100 may store map data representing geographic region 400 in storage unit 106 and/or memory module 108. Server 100 may divide geographic region 400 into a plurality of sub-regions, e.g., sub-regions, 1, 2, 3, . . . , 10. Server 100 may define the sub-regions according to any suitable method. In one embodiment, the sub-regions may be predetermined by an administrator of server 100. In another embodiment, server 100 may divide the sub-regions according to their zip codes. In another embodiment, server 100 may divide the sub-regions according to their designated functions in geographic region 400, such as financial districts, tourist areas, residential areas, industrial parks, shopping areas, etc. In yet another embodiment, server 100 may dynamically divide the sub-regions based on past determination of the cold zones and hot zones. For example, each sub-region may correspond to a previously-determined cold zone or hot zone.

Server 100 may determine the amount of supply based on the vehicle information received form service vehicles 20 or communication device 22. The vehicle information may include at least one of location, capacity, current driving direction, vehicle model, or other features of a service vehicle 20. Based on the vehicle information, server 100 may determine the number of service vehicles 20 in geographic region 400. Alternatively or additionally, server 100 may determine the number of service vehicles 20 in each sub-region of geographic region 400.

Server 100 may determine the amount of demand based on transportation service requests received from passengers 30 or passenger terminals 32. A transportation service request may include a current location of a passenger 30, an origin and a destination of the requested transportation service, a request time, or the like. Based on the transportation service requests, server 100 may determine the number of transportation service requests in geographic region 400. Alternatively or additionally, server 100 may determine the number of transportation service requests in each sub-region of geographic region 400.

Server 100 may determine the amounts of supply and demand at a predetermined time interval. To ensure the determined amounts of supply and demand reflect the real-time supply and demand of the transportation service, server 100 may set the predetermined time interval according to the driving speed of service vehicles 20 in the current traffic condition and/or the current average wait time experienced by passengers 30. For example, if the current traffic is slow, server 100 may use a long time interval because the number of service vehicles 20 (i.e., the amount of supply) in geographic region 400 or each sub-region of geographic region 400 changes slowly. As another example, if the current average wait time is short, server 100 may use a short time interval because the number of transportation service requests (i.e., the amount of demand) in geographic region 400 or each sub-region of geographic region 400 changes fast.

Referring back to FIG. 3, in step 304, server 100 may determine a plurality of cold zones and a plurality of hot zones in the geographic region. Specifically, when the amount of supply in a sub-region exceeds the amount of demand in the sub-region by a first predetermined value, server 100 may determine the sub-region to be a cold zone (or an over-supplied zone). In each cold zone, there are a number of on-duty service vehicles 20 that are available for picking up new passengers.

In contrast, when the amount of demand in a sub-region exceeds the amount of supply by a second predetermined value, server 100 may determine that the sub-region is a hot zone (or an under-supplied zone). In each hot zone, there are a number of unfulfilled transportation requests waiting in a queue.

In some embodiments, server 100 may compute a demand-supply density for geographic region 400 and/or each sub-region in the geographic region 400. The demand-supply density may be computed according to any suitable algorithm. In one embodiment, the demand-supply density may be defined as a ratio of (a) the amount of demand in a region (or sub-region) over (b) the amount of demand in the same region (or sub-region). In another embodiment, the demand-supply density may be defined as a ratio of (a) the number of transportation service requests in a region (or sub-region) that have not been assigned a service vehicle to (b) the number of service vehicles in the same region (or sub-region) that are available for picking up new transportation service requests. In the disclosed embodiments, server 100 may compute the demand-supply density for each predetermined time interval based on the real-time supply and demand data.

From the above description, it can be seen that the demand-supply density can measure the degree of a surplus or shortage of available service vehicles 20 in a region (or sub-region). Server 100 may further determine cold zones and/or hot zones based on the demand-supply density. For example, when the demand-supply density of a sub-region of geographic region 400 is above a first predetermined threshold, server 100 may determine that the sub-region is a hot zone. In contrast, when the demand-supply density of a sub-region of geographic 400 is below a second predetermined threshold, server 100 may determine that the sub-region is a cold zone.

Consistent with the disclosed embodiments, server 100 may set the values of the first and second predetermined thresholds based on historical supply and demand data. In practice, if the discrepancy between the supply and demand in a region (or sub-region) is small, the supply and demand sometimes can reach a balance through self-adjustments, and hence there is no need for server 100 to dispatch extra vehicles from cold zones to hot zones. In contrast, if the discrepancy between the supply and demand in a region (or sub-region) is too large, it may take a longer time for server 100 to re-balance the supply and demand in the region (or sub-region). As such, based on the historical supply and demand data, server 100 may keep the spread between the first and second predetermined thresholds in a proper range, so as to improve system efficiency and user experience.

In step 306, server 100 may generate dispatching information indicating at least one hot zone to notify an available service vehicle 20 in at least one cold zone. Specifically, server 100 may identify one or more available service vehicles 20 in one or more cold zones, based on the vehicle information of service vehicles 20. An available service vehicle 20 is a vehicle available for picking up a new passenger. For example, an available service vehicle 20 may be a vehicle which currently is on duty but carries no passengers. As another example, in car-pooling service, an available service vehicle 20 may be a vehicle which currently carries one or more passengers but has space to take additional passengers along its traveling route.

Server 100 may send the dispatching information to communication device 22 associated with an available service vehicle 20 in at least one cold zone. The dispatching information may include information identifying one or more of the plurality of hot zones by their position information (e.g., GPS coordinates), landmarks (e.g., city hall), popular names (e.g., “little Italy”), zone numbers (e.g., “zone 308”) predefined by the online hailing platform, etc. The dispatching information may also include information prompting available service vehicles 20 to pick up passenger in one or more hot zones.

According to method 300, server 100 can dispatch available service vehicles from one or more cold zones to one or more hot zones. This not only solves the shortage of service vehicles in the hot zones, but also reduces the waste of transportation capacity in the cold zones. Moreover, because server 100 plans the vehicle movement between the hot zones and cold zones in a geographic region as a whole and in real time, server 100 can avoid causing new imbalance of supply and demand in the geographic region. Therefore, the disclosed systems and methods improve the efficiency of dispatching vehicles.

To further improve the dispatching efficiency, the present disclosure also provides methods for dispatching available service vehicles from cold zones to hot zones based on the distances between the cold zones (or available service vehicles in the cold zones) and the hot zones.

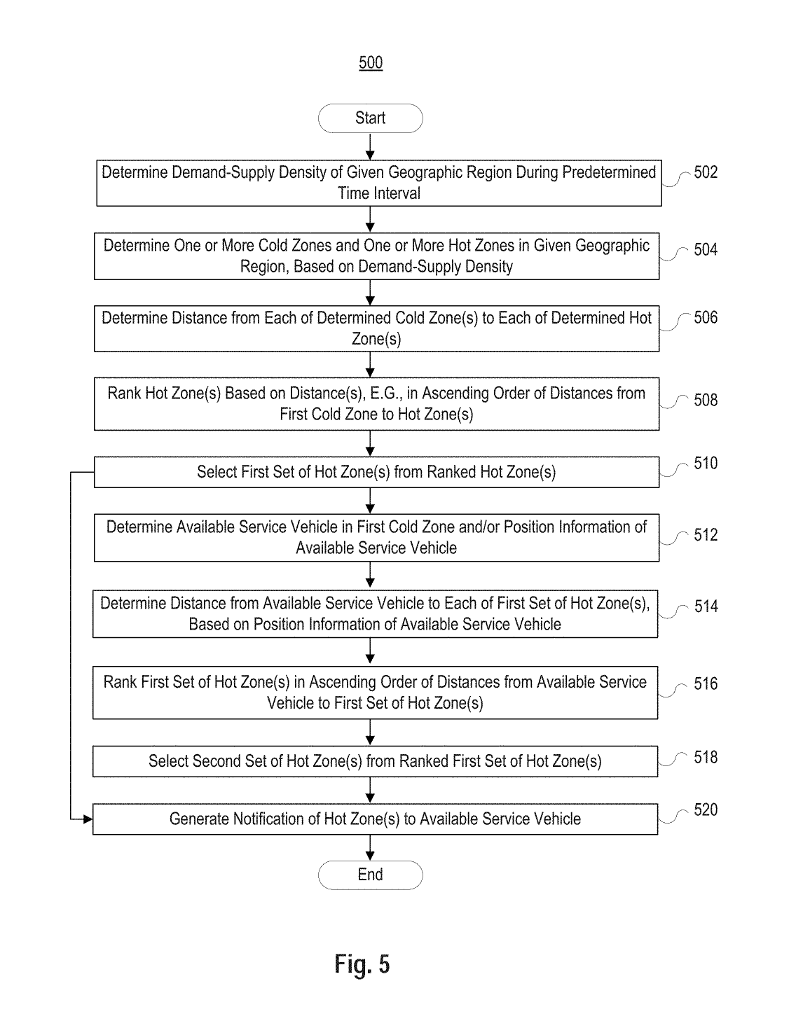

FIG. 5 is a flowchart of a method 500 for dispatching vehicles, according to an exemplary embodiment. For example, method 500 may be implemented by vehicle-dispatching server 100. Referring to FIG. 5, method 500 may include steps 502-520 as described below.

In step 502, server 100 may determine the demand-supply density of a transportation service in a given geographic region, e.g., geographic region 400 (FIG. 4), during a predetermined time interval. Referring to FIG. 4, server 100 may determine the demand-supply density of each sub-region of geographic region 400. The details for determining the demand-supply density are described in connection with steps 302 and 304, which will not be repeated herein.

In step 504, server 100 may determine one or more cold zones and one or more hot zones in geographic region 400, based on the demand-supply density. The details for determining cold zones and hot zones are described in connection with step 304, which will not be repeated herein.

In step 506, server 100 may determine a distance from each of the determined cold zone(s) to each of the determined hot zone(s). For example, the cold zone(s) may include a first cold zone. Server 100 may determine the geographic center of the first cold zone to the geographic center of each of the determined hot zone(s).

In step 508, server 100 may rank the hot zone(s) based on the distance(s), for example, in an ascending order of the distances from the first cold zone to the hot zone(s).

In step 510, server 100 may select a first set of hot zone(s) from the ranked hot zone(s). In some embodiments, server 100 may select a first predetermined number of highest ranked zone(s) from the ranked hot zone(s), as the first set of hot zone(s).

In some embodiments, after the first set of hot zone(s) is selected, server 100 may proceed to step 520 to generate a first notification indicating the first set of hot zone(s) and transmit the first notification to available service vehicles 20 located in the first cold zone. This way, the driver of an available service vehicle 20 receiving the first notification may select one of the first set of hot zone(s) and travel to the selected hot zone to pick up new passengers. Because the first set of hot zone(s) is close to the first cold zone, available service vehicles 20 in the first cold zone can be quickly dispatched to the first set of hot zone(s). Thus, the vehicle dispatching efficiency can be improved.

In some embodiments, after the first set of hot zone(s) is selected, server 100 may proceed to step 512 to determine a first available service vehicle 20 in the first cold zone and determine position information of the first available service vehicle 20. For example, the position information may be input by the driver of the first available service vehicle 20 into a communication device 22 associated with the first available service vehicle 20 and then transmitted by communication device 22 to server 100. Alternatively or additionally, the position information may be determined by communication device 22 based on GPS signals and/or GPRS communication, and then transmitted by communication device 22 to server 100.

Following step 512, server 100 may proceed to step 514 to determine a distance from the first available service vehicle 20 to each of the first set of hot zone(s), based on the position information of the first available service vehicle 20. For example, server 100 may determine the distance from the first available service vehicle 20 to the geographic center of each of the first set of hot zone(s).

Following step 514, server 100 may proceed to step 516 to rank the first set of hot zone(s) in an ascending order of the distances from the first available service vehicle to the first set of hot zone(s).

Following step 516, server 100 may proceed to step 518 to select a second set of hot zone(s) from the ranked first set of hot zone(s). In some embodiments, server 100 may select a second predetermined number of highest ranked zone(s) from the ranked first set of hot zone(s), as the second set of hot zone(s). The second predetermined number is equal to or less than the first predetermined number.

Following step 518, server 100 may proceed to step 520 to generate a second notification indicating the second set of hot zone(s) and transmit the second notification to communication device 22 associated with the first available service vehicle 20. In this way, the driver of the first available service vehicle 20 may select one of the second set of hot zone(s) and travel to the selected hot zone to pick up new passengers. Because the first available service vehicle 20 is close to the second set of hot zone(s), it can be quickly dispatched to one of the second set of hot zone(s). Thus, the vehicle-dispatching efficiency is improved.

In the disclosed embodiments, the first and second predetermined numbers may be set based on the number of available vehicles 20 in the cold zones, the number of transportation service requests in the hot zones that have not been assigned a service vehicle 20, and/or historical supply and demand data in geographic region 400. For example, if there is a large number of available service vehicles 20 in the cold zones, server 100 may set relatively large values for the first and/or second predetermined numbers so as to provide more choices of dispatching destinations for available service vehicles 20. As another example, if the supply shortage in the hot zones is relatively small, server 100 may set relatively large values for the first and/or second predetermined numbers, in order to prevent a large number of available service vehicles 20 from entering a single hot zone.

In some embodiments, server 100 may send the first and/or second notifications at a properly set frequency, in order not to cause excess interruption to drivers of the service vehicles.

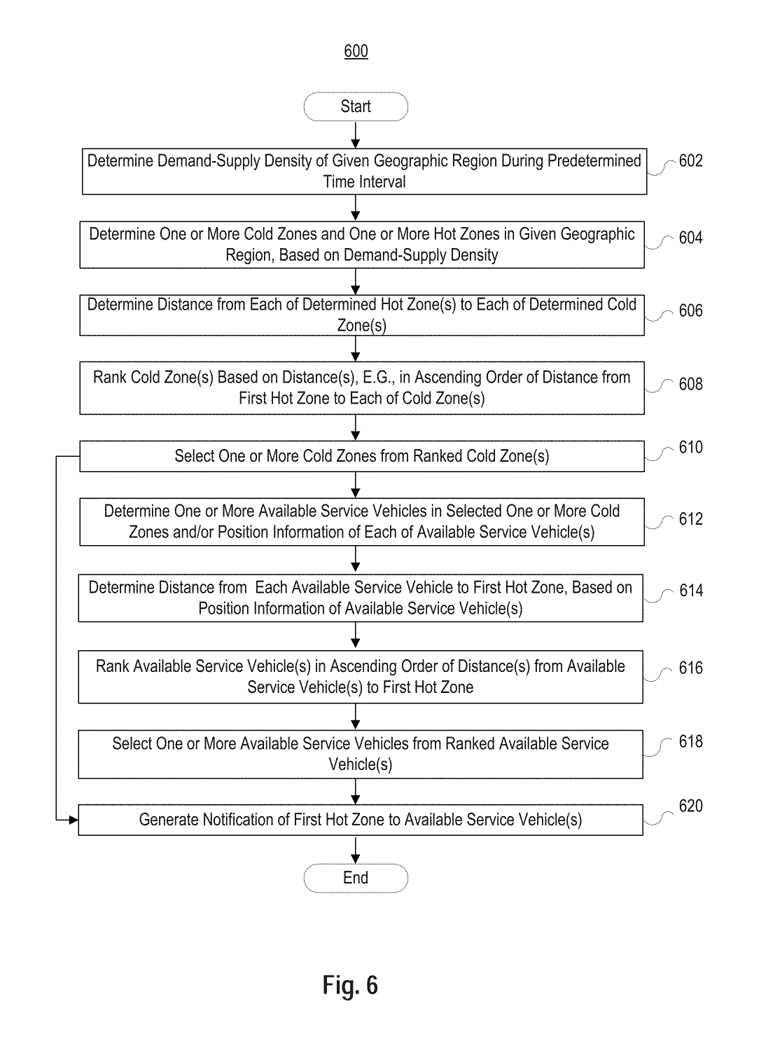

As described above, method 500 selects one or more hot zones close to an available service vehicle and dispatches the vehicle to the selected one or more hot zones, so as to improve the dispatching efficiency. FIG. 6 is a flowchart of a method 600 for dispatching vehicles, according to another exemplary embodiment. For example, method 600 may be implemented by vehicle-dispatching server 100. Unlike method 500, method 600 identifies one or more available service vehicles close to a hot zone and dispatches the vehicles to the hot zone. Referring to FIG. 6, method 600 may include steps 602-620 as described below.

In step 602, server 100 may determine the demand-supply density of a transportation service in a given geographic region, e.g., geographic region 400 (FIG. 4), during a predetermined time interval. Step 602 is similar to step 502.

In step 604, server 100 may determine one or more cold zones and one or more hot zones in geographic region 400, based on the demand-supply density. Step 604 is similar to step 504.

In step 606, server 100 may determine a distance from each of the determined hot zone(s) to each of the determined cold zone(s). For example, the determined hot zone(s) may include a first hot zone. Server 100 may determine the distance between the geographic center of the first hot zone to the geographic center of each of the determined cold zone(s).

In step 608, server 100 may rank the cold zone(s) based on the distance(s), for example, in an ascending order of the distance from the first hot zone to each of the cold zone(s).

In step 610, server 100 may select one or more cold zones from the ranked cold zone(s). In some embodiments, server 100 may select a first predetermined number of highest ranked cold zone(s) from the ranked cold zone(s).

In some embodiments, after the one or more cold zones are selected, server 100 may proceed to step 620 to determine a first available service vehicle 20 from the selected one or more cold zones and generate a first notification indicating information of the first hot zone to the first available service vehicle 20. Because the first available service vehicle 20 is selected from a cold zone close to the first hot zone, the first available service vehicle 20 can be quickly dispatched to the first hot zone. In this way, the vehicle dispatching efficiency can be improved.

In some embodiments, after the one or more cold zones are selected, server 100 may proceed to step 612 to determine one or more available service vehicles 20 in the selected one or more cold zones, and determine position information of each of the available service vehicle(s) 20. Similar to step 512, the position information may be manually input by driver(s) of the available service vehicle(s) 20, or automatically determined based on GPS signals and/or GPRS communication.

Following step 612, server 100 may proceed to step 614 to determine a distance from each available service vehicle 20 to the first hot zone, based on the position information of the available service vehicle(s) 20. For example, server 100 may determine the distance from each available service vehicle 20 to the geographic center of the first hot zone.

Following step 614, server 100 may proceed to step 616 to rank the available service vehicle(s) 20 in an ascending order of the distance(s) from the available service vehicle(s) 20 to the first hot zone.

Following step 616, server 100 may proceed to step 618 to select one or more available service vehicles 20 from the ranked available service vehicle(s) 20. In some embodiments, server 100 may select a second predetermined number of highest ranked available service vehicle(s) 20 from the ranked available service vehicle(s) 20.

In the disclosed embodiments, the first and second determined numbers may be set based on the number of available vehicles 20 in the cold zones, the number of transportation service requests in the hot zones that have not been assigned a service vehicle 20, and/or historical supply and demand data in geographic region 400. For example, if there is a large number of available service vehicles 20 in the cold zones, server 100 may set relatively large values for the first and/or second predetermined numbers so as to promote the first hot zone to more available service vehicles 20. As another example, if the supply shortage in the first hot zone is relatively small, server 100 may set relatively small values for the first and/or second predetermined numbers, in order to prevent a large number of available service vehicles 20 from entering the first hot zone.

Following step 618, server 100 may proceed to step 620 to generate a second notification indicating information of the first hot zone and transmit the second notification to communication devices 22 associated with the selected one or more available service vehicles 20. Because the selected one or more available service vehicles 20 are close to the first hot zone, they can be quickly dispatched to the first hot zone. In this way, the vehicle-dispatching efficiency is improved.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A computer-implemented method for dispatching vehicles, comprising:
determining, for a geographic region, supply and demand information for a transportation service during a predetermined time interval;
determining at least one over-supplied zone and at least one under-supplied zone within the geographic region, based on the supply and demand information; and
notifying a vehicle in the at least one over-supplied zone information of the at least one under-supplied zone, the vehicle being available for providing the transportation service.

2. The method of claim 1, wherein determining the at least one over-supplied zone and the at least one under-supplied zone based on the supply and demand information comprises:
for a sub-region of the geographic region, determining a demand-supply density for the transportation service in the sub-region;
when the demand-supply density is above a first predetermined threshold, determining that the sub-region is an under-supplied zone; and
when the demand-supply density is below a second predetermined threshold, determining that the sub-region is an over-supplied zone.

3. The method of claim 1, wherein the at least one over-supplied zone includes a first over-supplied zone and the at least one under-supplied zone includes a plurality of under-supplied zones, and wherein the method further includes:
determining distances from the first over-supplied zone to the plurality of under-supplied zones;
ranking the plurality of under-supplied zones based on the distances;
selecting a first set of under-supplied zones from the ranked plurality of under-supplied zones;
determining the vehicle available for providing the transportation service in the first over-supplied zone; and
notifying the vehicle information of the first set of under-supplied zones.

4. The method of claim 3, wherein selecting the first set of under-supplied zones from the ranked plurality of under-supplied zones includes:
selecting a predetermined number of highest ranked under-supplied zones as the first set of under-supplied zones from the ranked plurality of under-supplied zones, wherein the plurality of under-supplied zones are ranked in an ascending order of the distances from the first over-supplied zone to the plurality of under-supplied zones.

5. The method of claim 3, further comprising:
determining position information of the vehicle available for providing the transportation service;
determining a distance from the vehicle to each of the first set of under-supplied zones, based on the position information of the vehicle;
ranking the first set of under-supplied zones in an ascending order of the distances from the vehicle to the first set of under-supplied zones;
selecting a second set of under-supplied zones from the ranked first set of under-supplied zones; and
notifying the vehicle information of the second set of under-supplied zones.

6. The method of claim 5, wherein selecting the second set of under-supplied zones from the ranked first set of under-supplied zones includes:
selecting a predetermined number of highest ranked under-supplied zones from the ranked first set of under-supplied zones.

7. The method of claim 5, wherein determining position information of the vehicle available for providing the transportation service includes:
receiving the position information from a mobile communication device associated with the vehicle available for providing the transportation service, the mobile terminal being configured to automatically determine the position information of the vehicle.

8. The method of claim 1, wherein:
the at least one under-supplied zones includes a first under-supplied zone and the at least one over-supplied zones includes a plurality of over-supplied zones, and wherein the method further comprises:
determining distances from the first under-supplied zone to the plurality of over-supplied zones;
ranking the plurality of over-supplied zones based on the distances;
selecting one or more over-supplied zones from the ranked plurality of over-supplied zones;
determining the vehicle available for providing the transportation service in the selected one or more over-supplied zones; and
notifying the vehicle information of the first under-supplied zone.

9. The method of claim 8, wherein selecting the one or more over-supplied zones from the ranked plurality of over-supplied zones includes:
selecting a predetermined number of highest ranked over-supplied zones from the ranked plurality of over-supplied zones, wherein the plurality of over-supplied zones are ranked in an ascending order of the distances from the first under-supplied zone to the plurality of over-supplied zones.

10. The method of claim 8, further comprising:
determining, in the selected one or more over-supplied zones, position information of a plurality of vehicles available for providing the transportation service;
determining distances from the plurality of vehicles to the first under-supplied zone, based on the position information of the plurality of vehicles;
ranking the plurality of vehicles in an ascending order of the distances from the plurality of vehicles to the first under-supplied zone;
selecting one or more vehicles from the ranked plurality of vehicles; and
notifying the selected one or more vehicles information of the first under-supplied zone.

11. The method of claim 10, wherein selecting the one or more vehicles from the ranked plurality of vehicles includes:
selecting a predetermined number of highest ranked vehicles from the ranked plurality of vehicles.

12. The method of claim 1, wherein notifying the vehicle in the at least one over-supplied zone information of the at least one under-supplied zone includes:
generating dispatch information indicating the at least one under-supplied zone to the vehicle; and
transmitting the dispatch information to a communication device carried by the vehicle.

13. A device for dispatching vehicles, comprising:
a memory storing instructions; and
at least one processor configured to execute the instructions to:
determine, for a geographic region, supply and demand information for a transportation service during a predetermined time interval;
determine at least one over-supplied zone and at least one under-supplied zone within the geographic region, based on the supply and demand information; and
notify a vehicle in the at least one over-supplied zone information of the at least one under-supplied zone, the vehicle being available for providing the transportation service.

14. The device of claim 13, wherein the processor is further configured to:
for a sub-region of the geographic region, determine a demand-supply density for the transportation service in the sub-region;
when the demand-supply density is above a first predetermined threshold, determine that the sub-region is an under-supplied zone; and
when the demand-supply density is below a second predetermined threshold, determine that the sub-region is an over-supplied zone.

15. The device of claim 13, wherein the at least one over-supplied zone includes a first over-supplied zone and the at least one under-supplied zone includes a plurality of under-supplied zones, and wherein the processor is further configured to:
determine distances from the first over-supplied zone to the plurality of under-supplied zones;
rank the plurality of under-supplied zones based on the distances;
select a first set of under-supplied zones from the ranked plurality of under-supplied zones;
determine the vehicle available for providing the transportation service in the first over-supplied zone; and
notify the vehicle information of the first set of under-supplied zones.

16. The device of claim 15, wherein the processor is further configured to:
determine position information of the vehicle available for providing the transportation service;
determine a distance from the vehicle to each of the first set of under-supplied zones, based on the position information of the vehicle;
rank the first set of under-supplied zones in an ascending order of the distances from the vehicle to the first set of under-supplied zones;
select a second set of under-supplied zones from the ranked first set of under-supplied zones; and
notify the vehicle information of the second set of under-supplied zones.

17. The device of claim 13, wherein the at least one under-supplied zones includes a first under-supplied zone and the at least one over-supplied zones includes a plurality of over-supplied zones, and wherein the processor is further configured to:
determine distances from the first under-supplied zone to the plurality of over-supplied zones;
rank the plurality of over-supplied zones based on the distances;
select one or more over-supplied zones from the ranked plurality of over-supplied zones; and
determine the vehicle available for providing the transportation service in the selected one or more over-supplied zones; and
notify the vehicle information of the first under-supplied zone.

18. The device of claim 17, wherein the processor is further configured to:
determine, in the selected one or more over-supplied zones, position information of a plurality of vehicles available for providing the transportation service;
determine distances from the plurality of vehicles to the first under-supplied zone, based on the position information of the plurality of vehicles;
rank the plurality of vehicles in an ascending order of the distances from the plurality of vehicles to the first under-supplied zone;
select one or more vehicles from the ranked plurality of vehicles; and
notify the selected one or more vehicles information of the first under-supplied zone.

19. The device of claim 13, wherein the processor is further configured to:
generate dispatch information indicating the at least one under-supplied zone to the vehicle; and
wherein the device further comprises a communication interface coupled with the processor, wherein the processor is configured to transmit, via the communication interface, the dispatch information to a communication device carried by the vehicle.

20. A non-transitory computer-readable medium that stores a set of instructions, when executed by at least one processor of an electronic device, cause the electronic device to perform a method for dispatching vehicles, the method comprising:
determining, for a geographic region, supply and demand information for a transportation service during a predetermined time interval;
determining at least one over-supplied zone and at least one under-supplied zone within the geographic region, based on the supply and demand information; and
notifying a vehicle in the at least one over-supplied zone information of the at least one under-supplied zone, the vehicle being available for providing the transportation service.
